(19) United States
(12) Patent Application Publication
(10) Pub. No.: US 2020/0305620 A1
(43) Pub. Date: Oct. 1, 2020

(54) ENVIRONMENTALLY-FRIENDLY CUP AND METHOD OF MAKING THE SAME

(71) Applicant: CHI CHENG CO., LTD., Taipei City (TW)

(72) Inventor: Ching-Wen CHANG, TAICHUNG CITY (TW)

(21) Appl. No.: 16/507,530

(22) Filed: Jul. 10, 2019

(30) Foreign Application Priority Data
Apr. 1, 2019 (TW) 108111539

(51) Int. Cl. A47G 19/22; B65D 3/06; B31B 50/62; B31B 50/84

(52) U.S. Cl. CPC A47G 19/2266; B65D 3/06; B31B 2110/10; B31B 50/84; B31B 50/624

(57) ABSTRACT

An environmentally-friendly cup and method of making the same are provided. The environmentally-friendly cup includes a cup body and a cup base. The cup body is formed by curling a paper material that has a first and a second portion. The second portion has a first and a second straight side. The first portion is connected to the first straight side of the second portion and is curled into a straw. The straw is adhesively bonded to the second straight side of the second portion such that the second portion is curled into a tubular wall with a top opening and a bottom opening. The top end of the straw juts out of the top opening. The straw is directly formed on the cup body and therefore can be easily carried as an integral part of the environmentally-friendly cup without getting lost.

### BACKGROUND OF THE INVENTION

### 1. Technical Field

The present invention relates to an environmentally-friendly cup and more particularly to an environmentally-friendly cup and method of making the same.

### 2. Description of Related Art

Many people like to buy beverages, for example hand-shaken drinks that are served in a lidded cup or a cup whose opening is sealed with a plastic film, to quench their thirst while on the road. Generally, a cup of the aforesaid hand-shaken beverage is drunk through a disposable, or one-use, straw inserted into the cup either through a lid or through the film that seals the cup opening. As one-use straws are typically made of non-decomposable plastic material, the vast number of used plastic straws have become a serious threat to the environment.

While the market is now supplied with a variety of products intended to replace plastic straws (e.g., stainless steel straws, glass straws, and plant-fiber straws), these alternative straws have their respective drawbacks even if they comply with laws and regulations related to environmental protection. For example, a plant-fiber straw is lacking in structural strength, and a stainless steel or glass straw, though strong enough, presents difficulty in cleaning. Moreover, all the alternative straws on the market require extra care in order to be carried around, not to mention the advantage that they can get lost easily.

### BRIEF SUMMARY OF THE INVENTION

The primary objective of the present invention is to provide a cup that not only is environmentally-friendly, but also can be carried around conveniently without the risk of getting lost.

To achieve the above objective, the present invention provides an environmentally-friendly cup that includes a cup body and a cup base. The cup body is formed by curling a paper material that has a first portion and a second portion. The second portion has a first straight side and a second straight side. The first portion is connected to the first straight side of the second portion and is curled into a straw. The straw is adhesively bonded to the second straight side of the second portion such that the second portion is curled into a tubular wall. The tubular wall has a top opening and a bottom opening, and the top end of the straw juts out of the top opening. The cup base is adhesively bonded to the bottom end of the tubular wall of the cup body and thereby closes the bottom opening; as a result, the cup base and the cup body jointly form and surround a receiving space for holding a liquid.

According to the above, the environmentally-friendly cup of the present invention uses a special curling method to form the straw on the inner periphery, and as an integral part, of the cup body. Consequently, the drawbacks of the conventional straws, e.g., the inconvenience of being carried around and the high chance of getting lost, are overcome. Furthermore, the environmentally-friendly cup can be recycled to reduce the use of the conventional disposable straws and thereby contribute to environmental protection.

Preferably, the bottom end of the straw is not in contact with the cup base so that the liquid in the environmentally-friendly cup can flow easily into the straw.

Preferably, the bottom end of the straw has an obliquely cut portion so that the solid substances (e.g., tapioca balls) added into the liquid in the environmentally-friendly cup can flow easily into the straw through the obliquely cut portion without blocking the straw.

Preferably, the top end of the straw has a sucking section, and the sucking section may be corrugated or provided with a folding line in order to be received in the receiving space, allowing the top opening to be sealed with a film.

The present invention also provides a method for making the environmentally-friendly cup described above. To begin with, the first portion of the paper material is curled to form the straw, and an adhesive is applied to fix the straw in shape. Then, the straw is adhesively bonded to the second straight side of the second portion of the paper material, thereby curling the second portion of the paper material into the tubular wall, with the tubular wall and the straw constituting the cup body. Lastly, the cup base is adhesively bonded to the bottom end of the tubular wall to close the bottom opening, with the cup base and the cup body jointly forming and surrounding the receiving space.

The structural details, technical features, assembly method, and use of the environmentally-friendly cup of the present invention and the method for making the same can be better understood by referring to the following detailed description of some illustrative embodiments. However, as a person of ordinary skill in the art would understand, the detailed description and the specific embodiments disclosed therein serve explicative purposes only and are not intended to be restrictive of the scope of the invention.

### BRIEF DESCRIPTION OF THE SEVERAL VIEWS OF THE DRAWINGS

FIG. 1 is a perspective view of the environmentally-friendly cup according to the first embodiment of the present invention;

FIG. 2 is a sectional view of the environmentally-friendly cup according to the first embodiment of the invention;

FIG. 3a and FIG. 3b show a process flow by which the environmentally-friendly cup according to the first embodiment of the invention can be made; and

FIG. 4a and FIG. 4b show a process flow by which the environmentally-friendly cup according to the second embodiment of the invention can be made.

### DETAILED DESCRIPTION OF THE INVENTION

To start with, the applicant wishes to point out that all the directional terms used herein (including those used in the following embodiments and the appended claims) are in reference to the directions in the accompanying drawings. Besides, identical or similar elements or structural features in the following embodiments and the drawings are indicated by the same reference numeral.

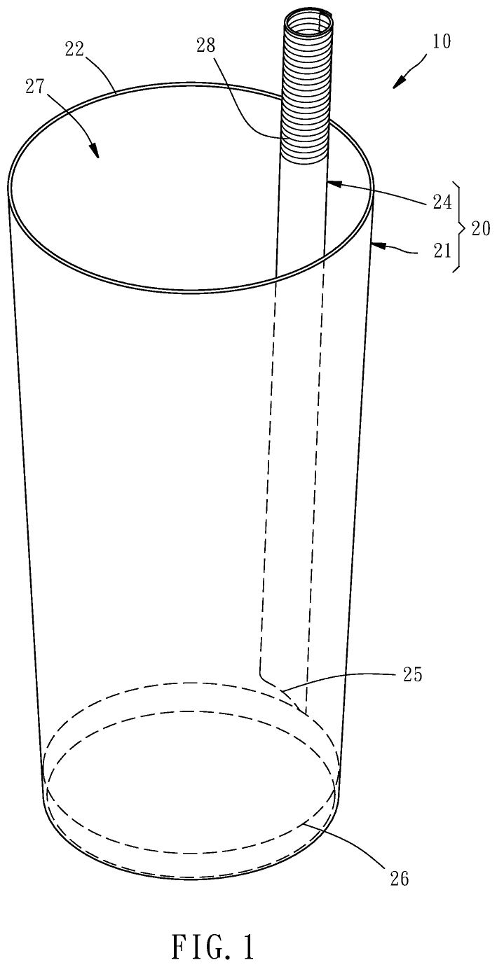

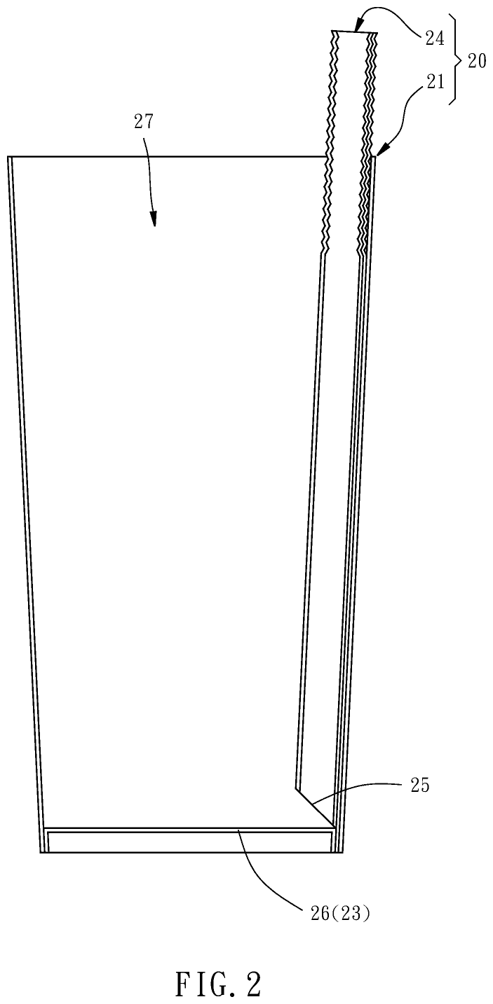

Referring to FIG. 1 and FIG. 2, the environmentally-friendly cup 10 according to the first embodiment of the present invention includes a cup body 20 and a cup base 26.

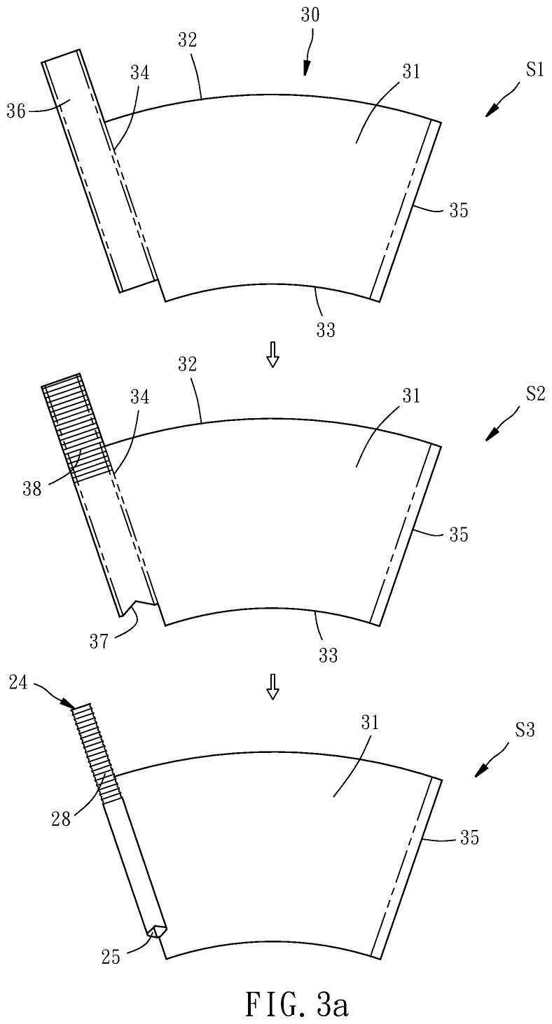

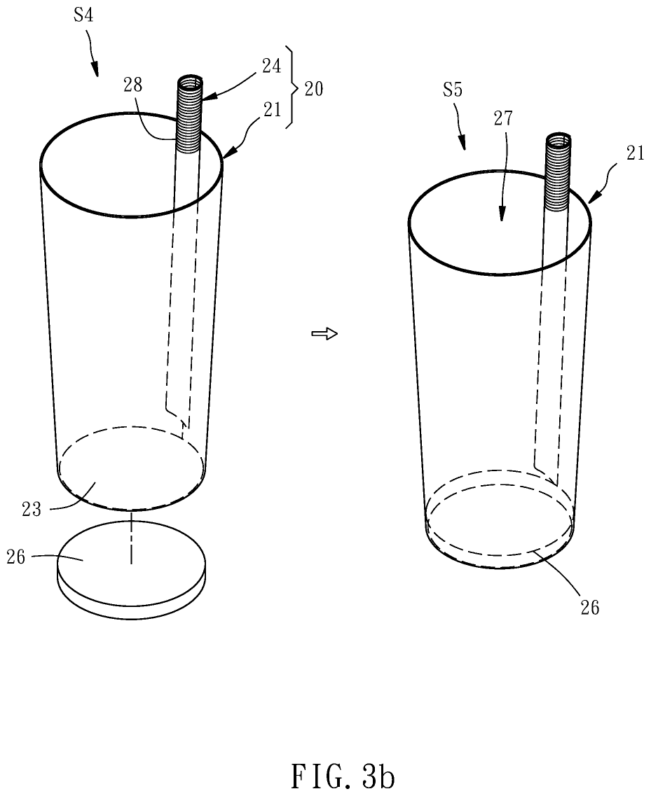

The cup body 20 is formed by curling a paper material 30. As shown in FIG. 3a, the paper material 30 has a first portion 36, which is in the shape of a straight strip, and a fan-like second portion 31. The second portion 31 has a convexly curved side 32, a concavely curved side 33, a first straight side 34, and a second straight side 35. The first portion 36 has one of its long sides connected to the first straight side 34 of the second portion 31, has a top end higher than the convexly curved side 32 of the second portion 31, and has a bottom end higher than the concavely curved side 33 of the second portion 31. The bottom end of the first portion 36 has an inverted V-shaped notch 37.

As shown in FIG. 1 and FIG. 2, the cup body 20 has a tubular wall 21 and a straw 24. The tubular wall 21 is formed by curling the second portion 31 in such a way that the convexly curved side 32 of the second portion 31 forms and surrounds a top opening 22 of the tubular wall 21, and that the concavely curved side 33 of the second portion 31 forms and surrounds a bottom opening 23 of the tubular wall 21. The straw 24 is formed by curling the first portion 36 and is adhesively bonded to the second straight side 35 of the second portion 31 such that the top end of the straw 24 juts out of the top opening 22 of the tubular wall 21 and forms a sucking section 28. While the straw 24 is being formed, the inverted V-shaped notch 37 of the first portion 36 is also curled to form an obliquely cut portion 25 of the straw 24. The obliquely cut portion 25 makes it easier for the solid substances (e.g., tapioca balls) added into the liquid in the environmentally-friendly cup 10 to flow into the straw 24, lest the straw 24 be blocked by those solid substances.

The cup base 26 is made of a circular piece of paper material. The cup base 26 is adhesively bonded to the bottom end of the tubular wall 21 of the cup body 20 to close the bottom opening 23 of the tubular wall 21; consequently, the cup base 26 and the cup body 20 jointly form and surround a receiving space 27 for holding a liquid. The cup base 26 is not in contact with the bottom end of the straw 24 so that the liquid in the receiving space 27 can flow into the straw 24 with ease.

Referring to FIG. 3a and FIG. 3b, the present invention further provides a method for making the environmentally-friendly cup 10, wherein the method includes the following steps:

1) In step S1 of FIG. 3a, the paper material 30 is cut to form the first portion 36 and the second portion 31.

2) In step S2 of FIG. 3a, the bottom end of the first portion 36 is cut to form the inverted V-shaped notch 37.

3) In step S3 of FIG. 3a, the first portion 36 of the paper material 30 is curled into the straw 24 and is fixed in shape with an adhesive, with the inverted V-shaped notch 37 of the first portion 36 curled up to form the obliquely cut portion 25 of the straw 24.

4) In step S4 of FIG. 3b, the straw 24 is adhesively bonded to the second straight side 35 of the second portion 31 such that the second portion 31 is curled up and forms the tubular wall 21, which together with the straw 24 constitutes the cup body 20.

5) In step S5 of FIG. 3b, the cup base 26 is adhesively bonded to the bottom end of the tubular wall 21 to close the bottom opening 23. Thus, the cup base 26 and the cup body 20 jointly form and surround the receiving space 27.

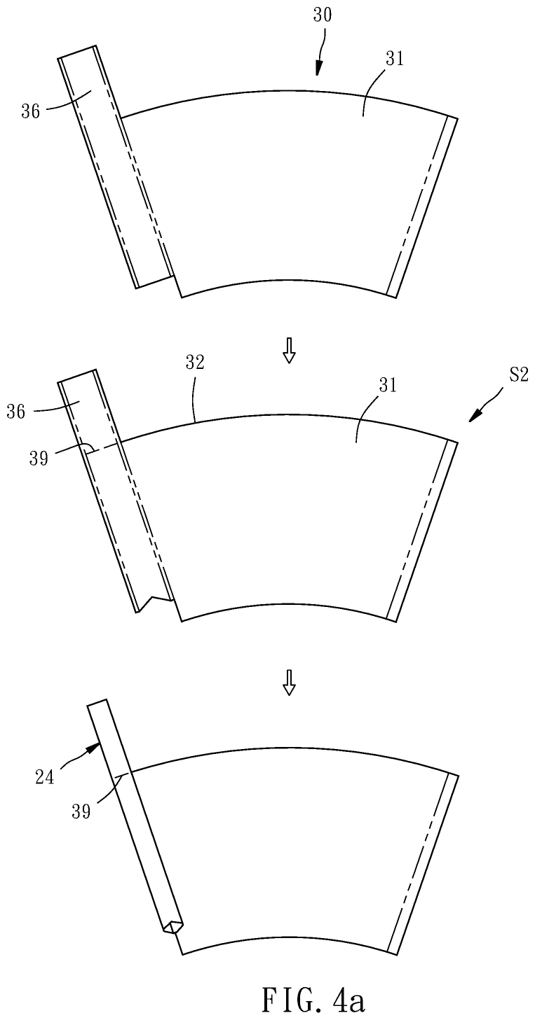

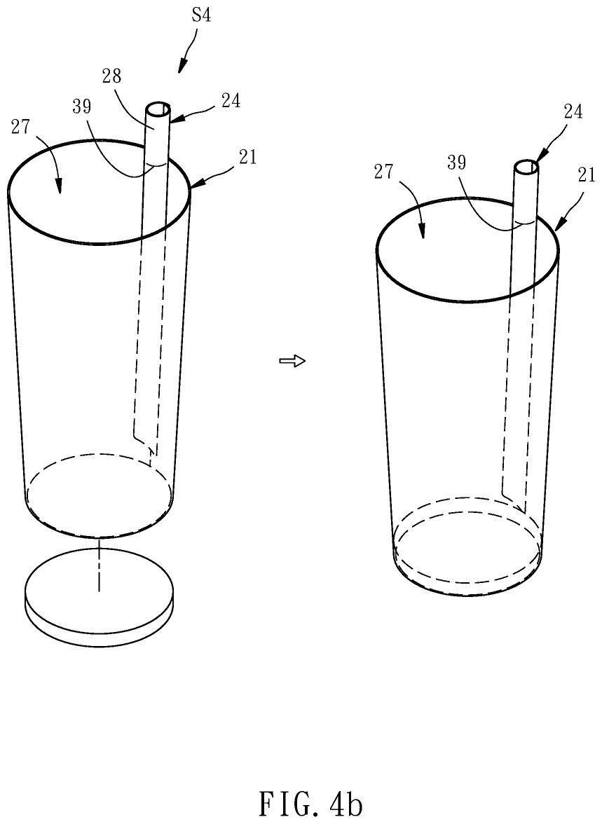

It should be pointed out that the first portion 36 and the second portion 31 may be integrally formed in the first place or be adhesively connected to each other. In other words, the first portion 36 and the second portion 31 may be cut out of the same piece of paper material as a single unit or be cut out of two pieces of paper material respectively and then adhesively connected together. Moreover, before the first portion 36 is curled into the straw 24, the top end of the first portion 36 may be processed to form a plurality of corrugations 38 (as shown in the drawing corresponding to step S2 of FIG. 3a), in order for the sucking section 28 of the straw 24 to have a corrugated structure. When corrugated, the sucking section 28 of the straw 24 can be compressed and received in the receiving space 27, allowing the top opening 22 to be subsequently sealed with a film. Alternatively, the first portion 36 in the second embodiment of the present invention is provided with a folding line 39 (as shown in the drawing corresponding to step S2 of FIG. 4a) before being curled into the straw 24, and the folding line 39 may be level with or lower than the convexly curved side 32 of the second portion 31 so that, once the first portion 36 is curled into the straw 24, the folding line 39 is adjacent to the sucking section 28 and is level with or lower than the top edge of the tubular wall 21, allowing the sucking section 28 of the straw 24 to be bent and received in the receiving space 27, and the top opening 22 to be subsequently sealed with a film. To use the straw 24 sealed in the receiving space 27, the user only has to peel off the portion of the film that corresponds in position to the straw 24 and then pull the sucking section 28 of the straw 24 out of the receiving space 27.

According to the above, the environmentally-friendly cup 10 disclosed herein uses a special curling method to form the straw 24 integrally with the inner periphery of the cup body 20. The straw 24, therefore, is unlike its prior art counterparts in that it can be easily carried as an integral part of the environmentally-friendly cup 10 and will not separate from the rest of the cup, let alone get lost. In addition, the environmentally-friendly cup 10 is friendly to the environment in that it can be recycled to reduce the wasteful use of the conventional disposable straws.

What is claimed is:

1. An environmentally-friendly cup, comprising:
a cup body formed by curling a paper material, wherein the paper material has a first portion and a second portion, the second portion has a first straight side and a second straight side, the first portion is connected to the first straight side of the second portion and is curled into a straw, the straw is adhesively bonded to the second straight side of the second portion such that the second portion is curled into a tubular wall, the tubular wall has a top opening and a bottom opening, and the straw has s top end jutting out of the top opening; and
a cup base adhesively bonded to a bottom end of the tubular wall of the cup body and closing the bottom opening such that the cup base and the cup body jointly form and surround a receiving space.

2. The environmentally-friendly cup of claim 1, wherein the first portion of the paper material and the second portion of the paper material are integrally formed.

3. The environmentally-friendly cup of claim 1, wherein the first portion of the paper material and the second portion of the paper material are adhesively connected to each other.

4. The environmentally-friendly cup of claim 1, wherein the straw has a bottom end spaced apart from the cup base.

5. The environmentally-friendly cup of claim 1, wherein the straw has a bottom end with an obliquely cut portion.

6. The environmentally-friendly cup of claim 1, wherein the top end of the straw has a corrugated sucking section.

7. The environmentally-friendly cup of claim 1, wherein the top end of the straw has a sucking section and a folding line adjacent to the sucking section, and the folding line is not higher than a top edge of the tubular wall.

8. A method for making the environmentally-friendly cup of claim 1, comprising the steps of:
a) curling the first portion of the paper material into the straw, and fixing the straw in shape;
b) adhesively bonding the straw to the second straight side of the second portion of the paper material such that the second portion of the paper material is curled into the tubular wall, wherein the tubular wall and the straw form the cup body; and
c) adhesively bonding the cup base to the bottom end of the tubular wall and thereby closing the bottom opening of the tubular wall such that the cup base and the cup body jointly form and surround the receiving space.

9. The method of claim 8, wherein the first portion of the paper material and the second portion of the paper material are integrally formed.

10. The method of claim 8, wherein the first portion of the paper material and the second portion of the paper material are adhesively connected to each other.

11. The method of claim 8, wherein the top end of the straw juts out of the top opening of the tubular wall.

12. The method of claim 8, wherein the straw has a bottom end spaced apart from the cup base.

13. The method of claim 8, wherein the step a) further comprises cutting a bottom end of the first portion of the paper material to form an inverted V-shaped notch, and the inverted V-shaped notch is curled into an obliquely cut portion when the first portion is curled into the straw.

14. The method of claim 8, wherein the step a) further comprises processing the first portion of the paper material to form a plurality of corrugations in order for the top end of the straw to form a corrugated sucking section.

15. The method of claim 8, wherein the step a) further comprises processing the first portion of the paper material to form a folding line in order for the top end of the straw to form a sucking section adjacent to the folding line, wherein the folding line is not higher than a top edge of the second portion of the paper material.
